(19) United States
(12) Patent Application Publication
(10) Pub. No.: US 2018/0103597 A1
(43) Pub. Date: Apr. 19, 2018

(54) Eavesdropper

(71) Applicant: Michelle Lapeyrouse, Harahan, LA (US)

(72) Inventor: Michelle Lapeyrouse, Harahan, LA (US)

(21) Appl. No.: 15/294,287

(22) Filed: Oct. 14, 2016

(51) Int. Cl. A01G 27/00; E04D 13/064; F16K 7/04; B01D 35/02; C02F 1/00

(52) U.S. Cl. CPC A01G 27/008; E04D 13/064; E04D 2013/086; B01D 35/02; C02F 1/00; F16K 7/04

(57) ABSTRACT

A rainwater diverter apparatus for watering roof plants is provided comprising a collecting member for retaining rainwater; a plastic tubing attached to the collecting member; a mesh screen to filter debris from entering the plastic tubing; and a swivel adaptor connected to the plastic tubing allowing for tube rotation.

### CROSS-REFERENCE TO RELATED APPLICATIONS

N/A

### BACKGROUND OF THE INVENTION

### Field of the Invention

The present invention relates to a method to water plants either hanging or potted using rain water captured from the eaves of a roof or gutter. More preferably, the present invention relates to an apparatus for diverting rainwater.

### Background of the Invention

Although a number of methods exist to water plants such as using a hose or drip irrigation system which require access to a pressured water system, or the use of a pitcher or other manual system such as plant water globes, if the water pressure fails or the plant owner does not water the plant, the plant will die. There are currently no methods of capturing rain water from the roof or gutter system and redirecting this water to either a potted or hanging plant.

It would be desirable to provide an improved apparatus for diverting rainwater from the downspout of a rain gutter system. However, the problems posed by this type of arrangement are complex because the known diverters tend to capture debris (e.g. leaves, dirt, ice, insects, etc.) that often results in clogging of the downspout and unreliable delivery of rainwater to an intended plant or some other container. For example, the known diverters tend to have structure that reduces the effective flow area through the downspout, or do not redirect the rainwater back through the downspout when the containment device is full, or that are not easy to clean, or that do not filter the rainwater being diverted to the collection device, or that include moving parts that reduce the reliability of the diverter.

Thus, there is a need in the art for an improved method to economically divert rainwater directly from the roof or gutter system of the house to a potted or hanging plant.

### BRIEF SUMMARY OF THE INVENTION

In one aspect of the invention a rainwater diverter apparatus for watering roof plants is provided comprising: a collecting member for retaining rainwater; a plastic tubing attached to the collecting member; a mesh screen to filter debris from entering the plastic tubing; and a swivel adaptor connected to the plastic tubing allowing for tube rotation.

In one embodiment, the apparatus is provided to divert rainwater directly to one or more plants placed under an eaves of a roof or porch. In another embodiment, the collecting member is provided to collect and store the rainwater for either diverting it to one or more plants or for later use. In another embodiment, the plastic tubing is provided to designate the path of the rainwater to reach directly to the one or more plants. In yet another embodiment, the plastic tubing is further connected to the swivel adapter and with a roller type clamp to control flow of the rainwater to prevent overwatering of the one or more plants. In one embodiment, the mesh screen is provided to filter unwanted debris from the rainwater and allow clean water to reach plants. In another embodiment, the apparatus is provided to be used in two different versions; one for a roof without gutters and another for roof with a gutter system. In one embodiment, the apparatus is provided for roof with a gutter system via a nylon hose barb positioned through a drilled hole in a piece of the gutter system, wherein the nylon hose barb is connected to the swivel adaptor, wherein an O-ring is inserted between the piece of the gutter system and collection member to prevent leakage. In another embodiment, the apparatus is provided for a roof without gutters via a clip, wherein the clip is used to attach the collection member to a shingle on the roof.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments. Referring to the drawings in which like reference character(s) present corresponding part(s) throughout:

FIG. 1 is an exemplary perspective view of an eavesdropper according to an embodiment of the present invention.

FIG. 2 is an exemplary detailed view of a diverter system according to an embodiment of the present invention.

FIG. 3 is an exemplary the diverter system of FIG. 2.

FIG. 4 is an exemplary perspective view of the hose washer connected with tubing through a piece of gutter according to an embodiment of the present invention.

FIG. 5 is an exemplary front view of an attaching hose washer connected tubing to the gutter according to an embodiment of the present invention.

FIG. 6 is an exemplary perspective view of a roller type clamp attached to the tubing according to an embodiment of the present invention.

FIG. 7 is an exemplary perspective view of an alternative clamp attached to the tubing to control the volume of water flow according to an embodiment of the present invention.

FIG. 8 is an exemplary perspective view of an alternative embodiment of the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

It is an object of the present invention to provide an apparatus for diverting rain water. It is a particular object of the present invention to provide an apparatus for capturing rain water from a roof or a gutter system and diverting the rain water to one or more plants potted or hanging off the roof. The present invention can be attached directly to a gutter or the edge of the roof and then redirect the captured rainwater towards one more plants.

In one embodiment, it is an object of the present invention to divert rainwater directly to plants that are sheltered and deprived of rain under the eaves of a roof or porch. Another object of the present invention is to provide two embodiments, one for a roof without gutters and one for a roof with a gutter system.

In one embodiment, the present invention can be certainly utilized to divert rainwater to a storage container for a later use if so desired.

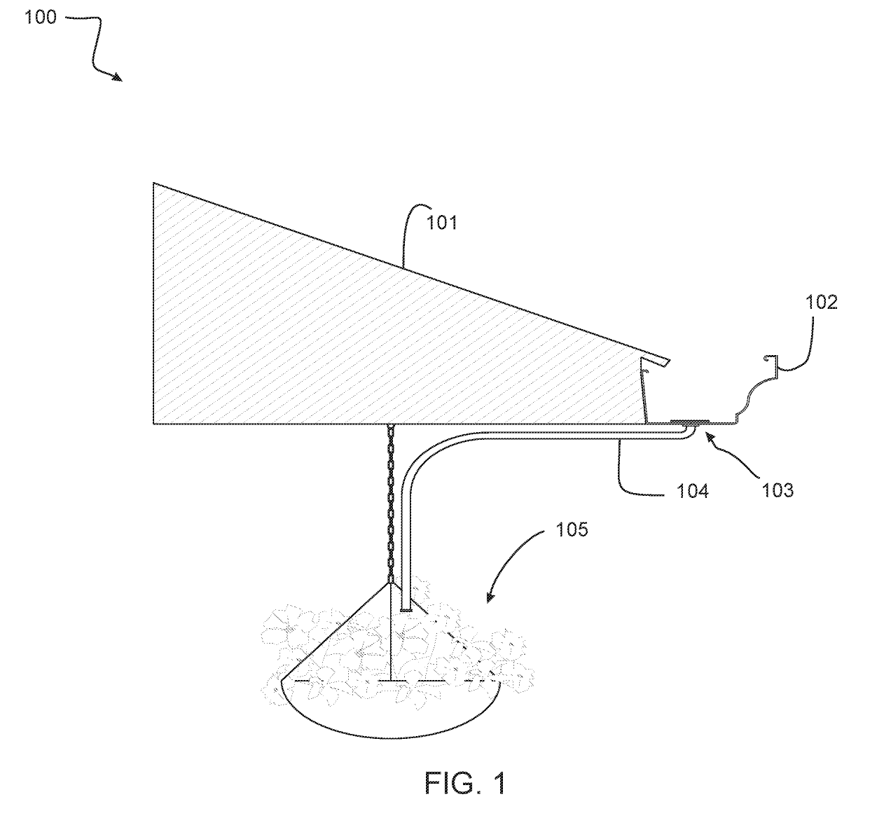

FIG. 1 is an exemplary perspective view of an eavesdropper 100 according to an embodiment of the present invention. Referring now to FIG. 1, a roof 101 with an attached gutter system 102 is illustrated. A diverter system 103 is positioned in a bottom portion of the gutter as shown. A tube 104 is attached to the diverter system, which directs rainwater collected in the gutter to one or more hanging plants 105. It is a particular object of the present invention to utilize the rainwater helping save water usages, while also watering one or more plants without human interaction improving efficiency a preventing the task of hand watering the one or more plants. In alternative embodiments, the one or more plants may be on a porch, under an awning, or any area that is deprived of rain water when raining.

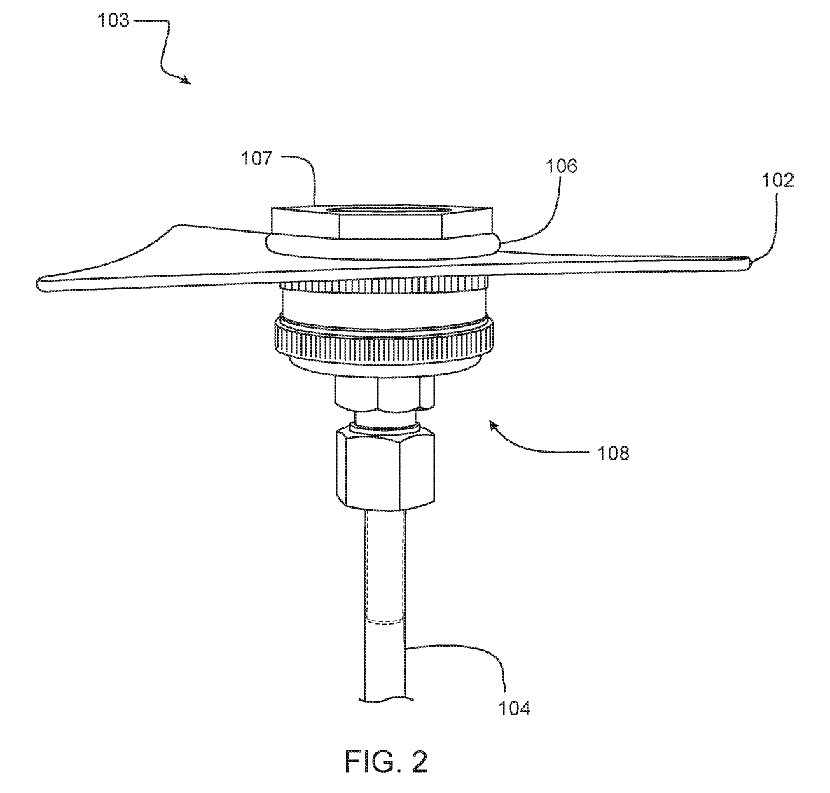

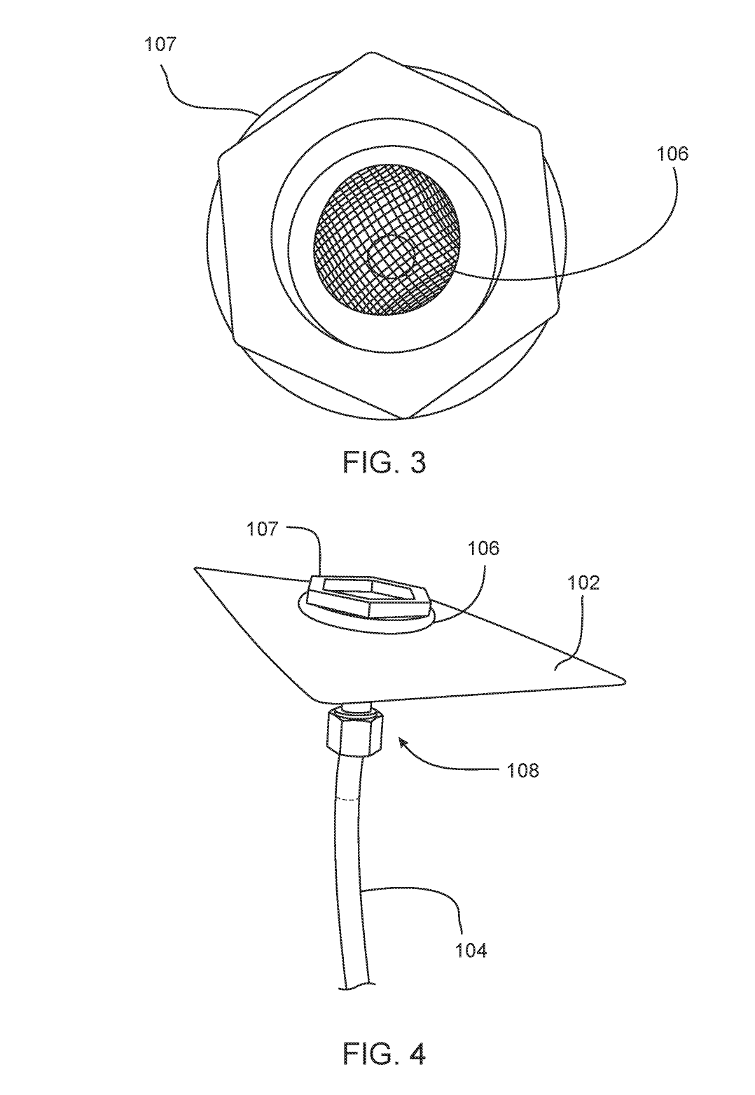

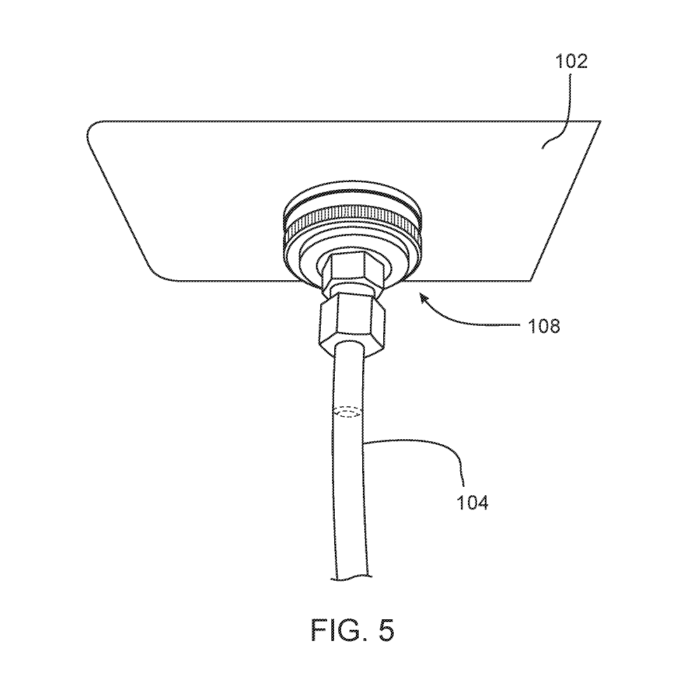

FIGS. 2-5 show various views of a diverter system 103 according to an embodiment of the present invention. Referring now to FIG. 2-5, the diverter system comprises a mesh screen 107 and hose washer 106 on the top side of a piece of gutter 102; and a swivel adapter element 108 and tube 104 on the bottom side of the piece of gutter. The piece of gutter represents any portion of the gutter system, and it is understood that the complete gutter system is not illustrated for convenience and to clearly show the present invention. The mesh screen is utilized to filter any debris from entering the tube, while the hose washer is used to prevent leakage between the connections. In one embodiment, O-rings are inserted between the connections in the gutter to prevent leakage and a hose washer with mesh screen. The swivel adapter element allows for 360 degree movement and rotation of the tube as well known in the art.

In one embodiment, the apparatus discloses a nylon hose barb 1″ ID×¾″ MIP connected to a swivel adapter ¾″ FH×¼″ OD, with O-rings inserted between the connections in the gutter to prevent leakage and a hose washer with mesh screen. In one embodiment, the tube is a ¼″ plastic tubing connected to the swivel adaptor and utilized a roller type clamp to control flow of the rainwater and thus prevent overwatering. This roller type clamp will be described in further detail below.

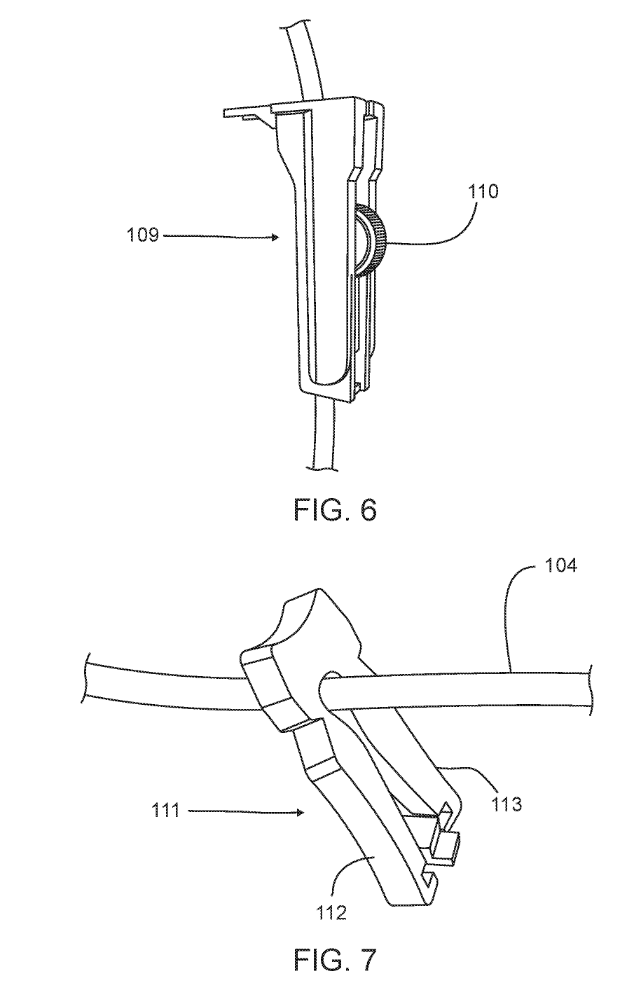

FIG. 6 is an exemplary perspective view of a roller type clamp 109 attached to the tubing according to an embodiment of the present invention. Referring now to FIG. 6, the roller type clamp is illustrated. The roller type clamp allows the water flow through the tube to be regulated. A rotating dial 110 is used to apply pressure on the tube and may be rotated counter clockwise to close or limit the flow of rain water. Likewise, the rotating dial may be rotated clockwise to open the flow of rainwater completely. The roller clamp allows a user to control the exact amount of water to the one or more plants to prevent over watering in periods of heavy rain or depending on the specific watering requirements of plant variety.

FIG. 7 is an exemplary perspective view of an alternative clamp 111 attached to the tubing to control the volume of water flow according to an embodiment of the present invention. Referring now to FIG. 7, the alternative clamp is illustrated. The alternative clamp comprises two clamp elements 112 and 113 designed to apply pressure to tube 104 to control the volume of rain water flow to the one or more plants to prevent over watering in periods of heavy rain or depending on the specific watering requirements of plant variety.

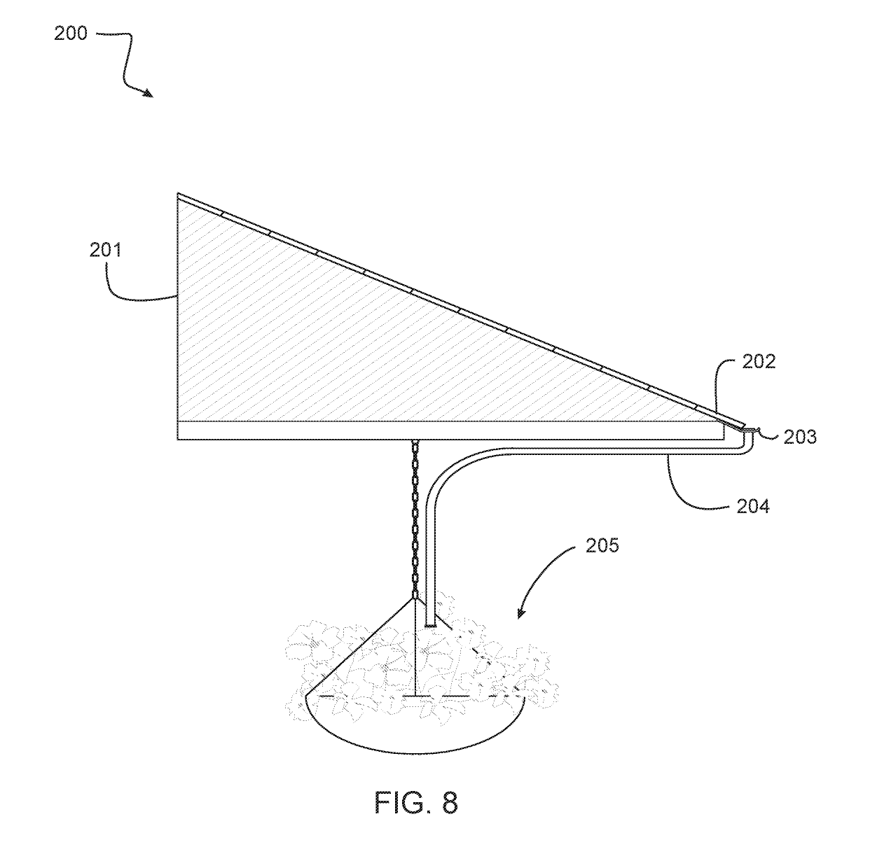

FIG. 8 is an exemplary perspective view of an alternative embodiment eavesdropper 200 of the present invention. The alternative embodiment allows the apparatus to be used in situations where no gutter system is present or installed. Referring now to FIG. 8, a roof 201 with shingles 202 is illustrated. A diverter system 203 is attached to a shingle utilizing roof clips. A tube 204 is attached to the diverter system, which directs rainwater to one or more hanging plants 205. It is a particular object of the present invention to utilize the rainwater helping save water usages, while also watering one or more plants without human interaction improving efficiency a preventing the task of hand watering the one or more plants. In alternative embodiments, the one or more plants may be on a porch, under an awning, or any area that is deprived of rain water when raining.

In one embodiment, the roof clips are the same type of device used to attach Christmas Lights, so that the filtered orifice of the invention catches rain runoff from the roof and it is diverted to the one or more plants. Otherwise, the roof with gutters version of the invention would attach directly to the gutter by drilling a hole through the base of the gutter and inserting the Eavesdropper, wherein, the filtered orifice would screw together utilizing O-rings to prevent leakage and divert the rainwater from the gutter to the plants.

In its another preferred embodiment, the present invention discloses an attachable tip on the plant end of the tubing that could sprinkle the water over a wider area as opposed to just dripping out of the bottom of the tubing onto one spot, wherein a hose washer with mesh screen is also provided to filter debris to prevent clogging of the tubing.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A rainwater diverter apparatus for watering roof plants comprising:
a collecting member for retaining rainwater;
a plastic tubing attached to the collecting member;
a mesh screen to filter debris from entering the plastic tubing; and
a swivel adaptor connected to the plastic tubing allowing for tube rotation.

2. The rainwater diverter apparatus of claim 1, wherein the apparatus is provided to divert rainwater directly to one or more plants placed under an eaves of a roof or porch.

3. The rainwater diverter apparatus of claim 1, wherein the collecting member is provided to collect and store the rainwater for either diverting it to one or more plants or for later use.

4. The rainwater diverter apparatus of claim 2, wherein the plastic tubing is provided to designate the path of the rainwater to reach directly to the one or more plants.

5. The rainwater diverter apparatus of claim 4, wherein the plastic tubing is further connected to the swivel adapter and with a roller type clamp to control flow of the rainwater to prevent overwatering of the one or more plants.

6. The rainwater diverter apparatus of claim 1, wherein the mesh screen is provided to filter unwanted debris from the rainwater and allow clean water to reach plants.

7. The rainwater diverter apparatus of claim 1, wherein the apparatus is provided to be used in two different versions; one for a roof without gutters and another for roof with a gutter system.

8. The rainwater diverter apparatus of claim 7, wherein the apparatus is provided for roof with a gutter system via a nylon hose barb positioned through a drilled hole in a piece of the gutter system, wherein the nylon hose barb is connected to the swivel adaptor, wherein an O-ring is inserted between the piece of the gutter system and collection member to prevent leakage.

9. The rainwater diverter apparatus of claim 7, wherein the apparatus is provided for a roof without gutters via a clip, wherein the clip is used to attach the collection member to a shingle on the roof.
